(19) United States
(12) Patent Application Publication
(10) Pub. No.: US 2014/0294073 A1
(43) Pub. Date: Oct. 2, 2014

(54) APPARATUS AND METHOD OF PROVIDING RECOMPRESSION OF VIDEO

(71) Applicant: Electronics and Telecommunications Research Institute, Daejeon (KR)

(72) Inventors: Seong-Mo PARK, Daejeon (KR); Kyung-Jin BYUN, Daejeon (KR); Nak-Woong EUM, Daejeon (KR)

(73) Assignee: Electronics and Telecommunications Research Institute, Daejeon (KR)

(21) Appl. No.: 14/210,179

(22) Filed: Mar. 13, 2014

(30) Foreign Application Priority Data
Mar. 27, 2013 (KR) 10-2013-0032572

(51) Int. Cl. H04N 19/423; H04N 19/426

(52) U.S. Cl. CPC H04N 19/00484; H04N 19/00503
USPC 375/240.12

(57) ABSTRACT

Disclosed herein are an apparatus and a method of providing recompression of a video capable of recompressing and transmitting flags of data having an association with neighboring data in a video block and an original video by a simple logic. To this end, the apparatus of providing recompression of a video includes: a recompressing unit recompressing a compressed video frame based on information obtained by comparing a selected block selected from the compressed video frame and an adjacent block adjacent to the selected block with each other; and a frame memory controlling unit storing the recompressed video frame in a frame memory. Therefore, a hardware volume may be decreased while original video data are maintained.

### CROSS REFERENCE TO RELATED APPLICATION

This application claims the benefit of Korean Patent Application No. 10-2013-0032572, filed on Mar. 27, 2013, 2013, entitled “Apparatus and Method of Providing Recompression of Video”, which is hereby incorporated by reference in its entirety into this application.

### BACKGROUND OF THE INVENTION

1. Technical Field

The present invention relates to an apparatus and a method of providing a recompression service of a video frame. More particularly, the present invention relates to an apparatus and a method of providing a recompression service of a video frame using a correlation between a specific block and a neighboring block of the specific block.

2. Description of the Related Art

In MPEG-1, MPEG-2, MPEG-4, H.263, H.264, or the like, which is a video image compression standard technology that is currently being mainly used, only a difference between a current frame and a frame predicted based on a previous frame is encoded and processed in order to accomplish high compression efficiency. Since one or more previous frame should be referenced in order to generate the predicted frame, the previous frame should be stored in a video frame memory. In the case in which a moving picture processing system is implemented by hardware, a size of the video frame memory required as described above is an importance factor. Therefore, many studies on a method of decreasing a size and a bandwidth of the video frame memory have been conducted.

A method of recompressing a frame memory is a method of recompressing data stored in the frame memory to decrease a size of the used memory. In the method of recompressing a frame memory, since the compressed data are transmitted, a used bandwidth is decreased.

As one of the methods for recompressing a frame memory, there is a frequency transform based method of dividing a frame into small blocks of data and transforming the small blocks of data into data in a frequency domain by discrete cosine transform (DCT), Hadamard transform, or a method similar to the DCT or the Hadamard transform to quantize the data in the frequency domain, thereby recompressing the data. The quantized data are compressed in a Golumb-Rice coding scheme, or the like, which is a variable length encoding scheme. Since this method generally requires a large amount of calculation in order to minimize damage to video quality due to the recompression, a lot of hardware for implementing this method is required. In addition, a propagation problem of an error may not be solved, and a time required for decoding a recompressed video frame may also be increased.

As another method, there is a downsampling method. The downsampling method has an advantage in that an amount of calculation is relatively smaller and hardware is more easily implemented as compared with the frequency transform based scheme. However, since a lot of information is lost in a compression process of downsampling and a reconstruction process of upsampling, the downsampling method is inefficient in terms of compression efficiency. Therefore, it is difficult to compress a video frame at a high compression rate.

Since the methods for recompressing a frame memory according to the related art are performed regardless of a used video image compression standard, information that may be obtained in a process of compressing a video image is not used, and a volume of hardware is increased or video quality is deteriorated.

Meanwhile, Korean Patent Laid-Open Publication No. 2009-0030478 has suggested a method of decreasing a size of a used memory while minimizing an effect on video quality of a corresponding video frame using information that may be obtained in an intra-prediction process such as H.264/AVC, or the like. In Korean Patent Laid-Open Publication No. 2009-0030478, a method of recompressing a specific video frame, performing an intra-prediction process, a quantization difference pulse coding modulation (DPMC) process, and a GR coding process on the recompressed video frame, and transmitting the video frame subjected to the above-mentioned processes to a memory has been suggested. However, the method suggested in Korean Patent Laid-Open Publication No. 2009-0030478, which is a method using an intra-prediction method and quantization, basically has a problem that original data are not maintained.

### SUMMARY OF THE INVENTION

An object of the present invention is to provide an apparatus and a method of providing recompression of a video capable of recompressing and transmitting flags of data having an association with neighboring data in a video block and an original video by a simple logic.

However, an object of the present invention is not limited to the object described above, and other objects that are not stated may be clearly understood by those skilled in the art from the following description.

According to an exemplary embodiment of the present invention, there is provided an apparatus of providing recompression of a video, including: a recompressing unit recompressing a compressed video frame based on information obtained by comparing a selected block selected from the compressed video frame and an adjacent block adjacent to the selected block with each other; and a frame memory controlling unit storing the recompressed video frame in a frame memory.

The recompressing unit may include: an adjacent block processing unit extracting and storing blocks adjacent to the selected block from the compressed video frame; a block comparing unit comparing the adjacent block selected among the stored blocks and the selected block with each other in a pixel unit; a pixel information obtaining unit obtaining information on a first pixel of the selected block having a pixel value that is the same as that of the adjacent block and information on a second pixel of the selected block having a pixel value that is different from that of the adjacent block; and a recompression controlling unit controlling recompression of the compressed video frame by packing the obtained information on the first pixel and the obtained information on the second pixel.

The pixel information obtaining unit may obtain a pixel value as the information on the first pixel and obtain address information on a pixel and a pixel value as the information on the second pixel.

The apparatus of providing recompression of a video may further include: a reconstruction memory storing the compressed video frame therein; a first address generating unit generating address information on a pixel selected from the selected block when the compressed video frame is recompressed; a re-reconstructing unit reading the recompressed video frame from the frame memory and re-reconstructing the read recompressed video frame; and a second address generating unit generating address information on a pixel in a block of the recompressed video frame.

The re-reconstructing unit may include: a comparison information generating unit generating the information obtained by comparing the selected block and the adjacent block with each other by unpacking the recompressed video frame; a comparison information storing unit storing the information obtained by comparing the selected block and the adjacent block with each other therein; and a re-reconstruction controlling unit controlling re-reconstruction of the recompressed video frame based on the information obtained by comparing the selected block and the adjacent block with each other.

The apparatus of providing recompression of a video may be mounted in a video codec.

According to another exemplary embodiment of the present invention, there is provided a method of providing recompression of a video, including: a recompressing step of recompressing a compressed video frame based on information obtained by comparing a selected block selected from the compressed video frame and an adjacent block adjacent to the selected block with each other; and a frame memory control step of storing the recompressed video frame in a frame memory.

The recompressing step may include: an adjacent block processing step of extracting and storing blocks adjacent to the selected block from the compressed video frame; a block comparing step of comparing the adjacent block selected among the stored blocks and the selected block with each other in a pixel unit; a pixel information obtaining step of obtaining information on a first pixel of the selected block having a pixel value that is the same as that of the adjacent block and information on a second pixel of the selected block having a pixel value that is different from that of the adjacent block; and a recompression controlling step of controlling recompression of the compressed video frame by packing the obtained information on the first pixel and the obtained information on the second pixel.

In the pixel information obtaining step, a pixel value may be obtained as the information on the first pixel and address information on a pixel and a pixel value may be obtained as the information on the second pixel.

The method of providing recompression of a video may further include a re-reconstructing step of reading the recompressed video frame from the frame memory and re-reconstructing the read recompressed video frame. The re-reconstructing step may be performed after the frame memory control step.

The re-reconstructing step may include: a comparison information generating step of generating the information obtained by comparing the selected block and the adjacent block with each other by unpacking the recompressed video frame; a comparison information storing step of storing the information obtained by comparing the selected block and the adjacent block with each other therein; and a re-reconstruction controlling step of controlling re-reconstruction of the recompressed video frame based on the information obtained by comparing the selected block and the adjacent block with each other.

The method of providing recompression of a video may be used when a video codec is generated.

### BRIEF DESCRIPTION OF THE DRAWINGS

FIG. 1 is a block diagram schematically showing an apparatus of providing recompression of a video according to an exemplary embodiment of the present invention.

FIG. 2 is a block diagram showing internal components of a recompressing unit shown in FIG. 1 in detail.

FIG. 3 is a block diagram schematically showing internal components added to the apparatus of providing recompression of a video of FIG. 1.

FIG. 4 is a block diagram showing internal components of a re-reconstructing unit shown in FIG. 3 in detail.

FIG. 5 is a view showing a structure of recompressing a frame memory according to an exemplary embodiment of the present invention.

FIGS. 6 and 7 are reference views for describing a method of recompressing a video frame.

FIG. 8 is a flow chart schematically showing a method of providing recompression of a video according to an exemplary embodiment of the present invention.

### DESCRIPTION OF THE EXEMPLARY EMBODIMENTS

Hereinafter, exemplary embodiments of the present invention will be described in detail with reference to the accompanying drawings. First, it is to be noted that in giving reference numerals to components of each of the accompanying drawings, the same components will be denoted by the same reference numerals even though they are illustrated in different drawings. Further, in describing exemplary embodiments of the present invention, well-known functions or constructions will not be described in detail since they may unnecessarily obscure the understanding of the present invention. In addition, although exemplary embodiments of the present invention will be described below, the scope of the present invention is not limited thereto, but may be variously modified by those skilled in the art.

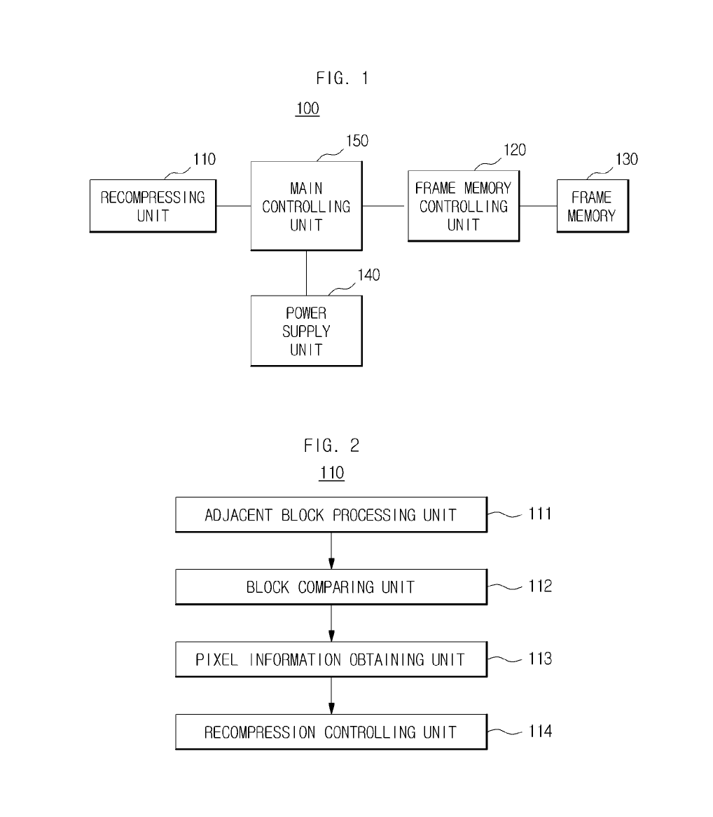

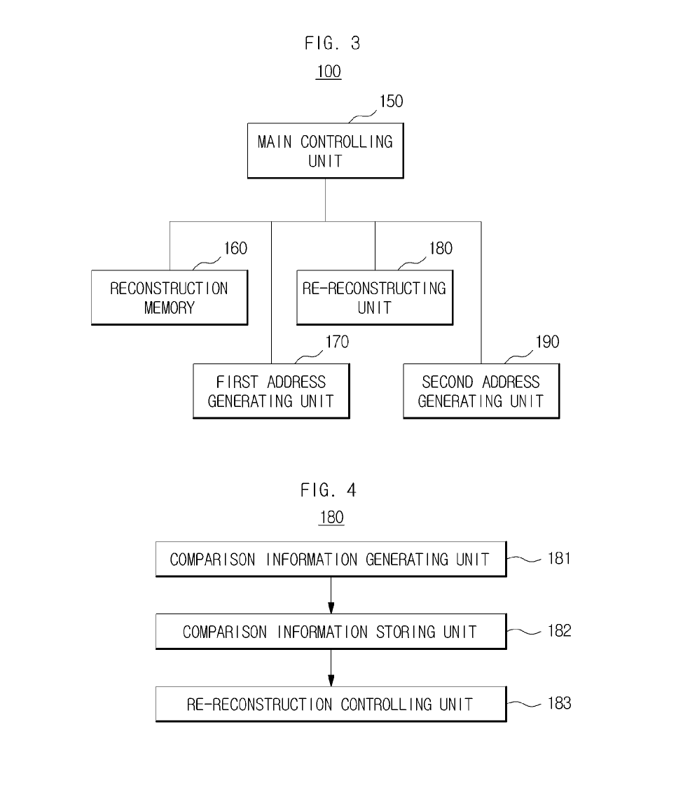

FIG. 1 is a block diagram schematically showing an apparatus of providing recompression of a video according to an exemplary embodiment of the present invention. FIG. 2 is a block diagram showing internal components of a recompressing unit shown in FIG. 1 in detail. FIG. 3 is a block diagram schematically showing internal components added to the apparatus of providing recompression of a video of FIG. 1. FIG. 4 is a block diagram showing internal components of a re-reconstructing unit shown in FIG. 3 in detail.

Referring to FIG. 1, an apparatus 100 of providing recompression of a video is configured to include a recompressing unit 110, a frame memory controlling unit 120, a frame memory 130, a power supply unit 140, and a main controlling unit 150.

The recompressing unit 110 serves to recompress a compressed video frame based on information obtained by comparing a selected block selected from the compressed video frame and an adjacent block adjacent to the selected block with each other.

The recompressing unit 110 includes an adjacent block processing unit 111, a block comparing unit 112, a pixel information obtaining unit 113, and a recompression controlling unit 114, as shown in FIG. 2.

The adjacent block processing unit 111 serves to extract and store blocks adjacent to the selected block from the compressed video frame.

The block comparing unit 112 serves to compare the adjacent block selected among the stored blocks and the selected block with each other in a pixel unit.

The pixel information obtaining unit 113 serves to obtain information on a first pixel of the selected block having a pixel value that is the same as that of the adjacent block and information on a second pixel of the selected block having a pixel value that is different from that of the adjacent block. The pixel information obtaining unit 113 obtains a pixel value as the information on the first pixel and obtains address information on a pixel and a pixel value as the information on the second pixel.

The recompression controlling unit 114 serves to control recompression of the compressed video frame by packing the obtained information on the first pixel and the obtained information on the second pixel.

The frame memory controlling unit 120 serves to store the recompressed video frame in the frame memory 130.

The power supply unit 140 serves to supply power to each component configuring the apparatus 100 of providing recompression of a video.

The main controlling unit 150 serves to control a general operation of each component configuring the apparatus 100 of providing recompression of a video.

The apparatus 100 of providing recompression of a video may further include a reconstruction memory 160, a first address generating unit 170, a re-reconstructing unit 180, and a second address generating unit 190, as shown in FIG. 3.

The reconstruction memory 160 is a component storing the compressed video frame therein.

The first address generating unit 170 serves to generate address information on a pixel selected from the selected block when the compressed video frame is recompressed.

The re-reconstructing unit 180 serves to read the recompressed video frame from the frame memory and re-reconstruct the read recompressed video frame.

The re-reconstructing unit 180 includes a comparison information generating unit 181, a comparison information storing unit 182, and a re-reconstruction controlling unit 183, as shown in FIG. 4.

The comparison information generating unit 181 serves to generate the information obtained by comparing the selected block and the adjacent block with each other by unpacking the recompressed video frame.

The comparison information storing unit 182 serves to store the information obtained by comparing the selected block and the adjacent block with each other therein.

The re-reconstruction controlling unit 183 serves to control re-reconstruction of the recompressed video frame based on the information obtained by comparing the selected block and the adjacent block with each other.

The second address generating unit 190 serves to generate address information on a pixel in a block of the recompressed video frame.

The apparatus 100 of providing recompression of a video described above is mounted in a video codec.

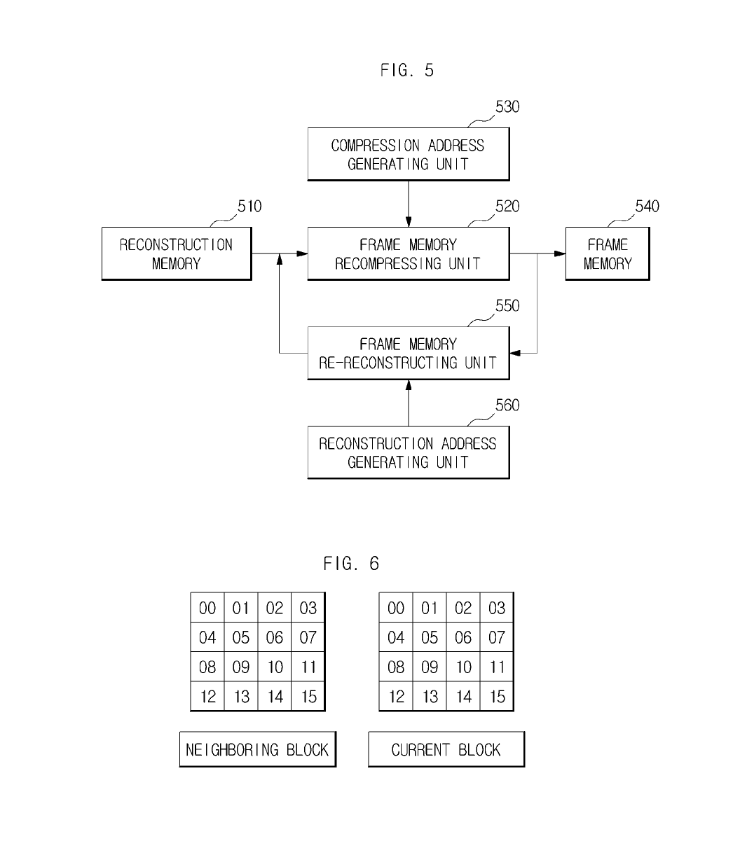

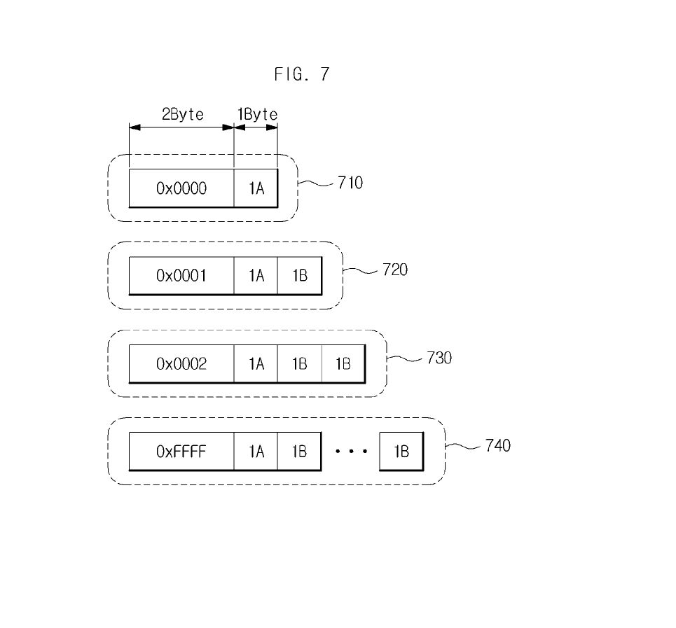

Next, an exemplary embodiment of the present invention will be described with reference to FIGS. 5 to 7. FIG. 5 is a view showing a structure of recompressing a frame memory according to an exemplary embodiment of the present invention. FIGS. 6 and 7 are reference views for describing a method of recompressing a video frame.

H.264 jointly developed by the video coding experts group (VCEG) of the international telecommunications union telecommunication (ITU-T) and the moving picture experts group (MPEG) of the international organization for standardization/international electro-technical commission joint technical committee (ISO/IEC), which are international moving picture standardization groups, has been established as a standard in 2005. Recently, standardization of the high efficiency video coding (HEVC) of which a main technical object is to improve a compression rate as compared with the H.264 has been conducted.

The HEVC, which is the next generation multimedia moving picture compression standard, is a general moving picture encoding technology that may be used in most of the transmission media such as a storage media, the Internet, satellite broadcasting, and the like, and environments of various moving picture resolutions. The VCEG of the ITU-T and the MPEG of the ISO/IEC that have developed the H.264/AVC have formed a team on January, 2010 as the joint collaborative team on video coding (JCT-VC), have developed the HEVC, and have completed a standard of the HEVC in 2013.

Traditionally, the ITU has established moving picture encoding standards such as H.261, H.263, H.264, and the like, based on wired communication media, and the MPEG has established MPEG-1, MPEG-2, and the like, for processing a moving picture in storage media or broadcasting media as standards. In addition, the MPEG has established an MPEG-4 moving picture standard realizing various functions mainly characterized by an object based moving picture code and a high compression rate in the MPEG-4, which is a code standard throughout multimedia. The VCEG of the ITU-T has continuously established a high compression rate moving picture standard called H.26L after it had established the MPEG-4 moving picture standard. It has been shown in a formal comparison experiment of the MPEG that H.26L is significantly more excellent in terms of a compression rate than the MPEG-4 moving picture standard (advanced simple profile) having a function similar to that of H.26L. Therefore, the MPEG has decided to develop H.264/AVC, which is a join video team (JVT) moving picture standard, together with the VCEG of the ITU based on H.26L.

In the market, a system on chip (SoC) capable of processing ultra high definition and high resolution has been currently demanded. To this end, the present invention suggests an apparatus and a method of recompressing and transmitting flags of data having an association with neighboring data in a video block and an original video by a simple logic. According to the present invention, the same data are not redundantly transmitted while original data are maintained, thereby making it possible to improve a compression rate of a frame memory and process video data in real time at a small hardware area.

Referring to FIG. 5, a structure of recompressing a frame memory according to an exemplary embodiment of the present invention is configured to include a reconstruction memory 510, a frame memory recompressing unit 520, a compression address generating unit 530, a frame memory 540, a frame memory re-reconstructing unit 550, and a reconstruction address generating unit 560.

The reconstruction memory 510 stores data transmitted to and received from an external memory (not shown) therein. Reconstructed data stored in the reconstruction memory 510 mean data significantly similar to original video data. For example, the reconstructed data mean data generated by primarily compressing the original video data.

The frame memory recompressing unit 520 recompresses the reconstructed data using similarity to a neighboring block and transmits the recompressed reconstructed block to the frame memory 540.

The frame memory recompressing unit 520 includes a storage, a comparator, and a packing module.

The storage stores the neighboring block therein.

The comparator compares the neighboring block and a current block with each other. A neighboring block and a current block that have a 4×4 form are shown, respectively, by way of example in FIG. 6. The comparator compares data positioned at the same position in the respective blocks with each other.

The packing module packs final data and flags. Packing results in the case in which the neighboring block and the current block that have the 4×4 form are compared with each other are shown in FIG. 7.

Reference numeral 710 indicates a result value in the case in which all data of the current block are the same as those of the neighboring block. In this case, a flag bit of two bytes is represented by 0x0000, and only one data is transmitted.

Reference numeral 720 indicates a result value in the case in which a data positioned at a first address in the current block is different from that of the neighboring block and the other data are the same as those of the neighboring block. In this case, in a form of 0x0001,1A,1B, the same data is transmitted as one data and different data are transmitted as (one) the other data.

Reference numeral 730 indicates a result value in the case in which data positioned at first and second addresses in the current block are different from those of the neighboring block and the other data are the same as those of the neighboring block.

Reference numeral 730 indicates a result value in the case in which all data of the current block are different from those of the neighboring block. In this case, 16 data are transmitted in a form of 0xFFFF.

Since most of the data are similar to those of the neighboring block, a compression rate improved by 50% was shown as an experiment result. Even though an overhead of a flag and a circuit for generating an address are considered, a compression rate was improved by 50% without deteriorating video quality of original data and a memory bandwidth problem was also improved.

The compression address generating unit 530 generates addresses of data in the case in which the data of the current block are different from those of the neighboring block.

The frame memory re-reconstructing unit 550 re-reconstructs data in the case in which the frame memory 540 reads the data. The frame memory re-reconstructing unit 550 includes an unpacking module, a storage, and a comparator.

In the case in which a system on chip (SoC) is implemented based on a moving picture compression standard, entire performance is decreased due to frequent transfer of data between an external frame memory and an internal memory. In the present invention described above, frame memory data are compressed using similarity to the neighboring block and are transferred to the external frame memory. Therefore, the present invention has an effect that a video may be processed in real time at a small hardware area without deteriorating video quality. The present invention may be implemented by a video codec SoC using an algorithm compressing video data as hardware.

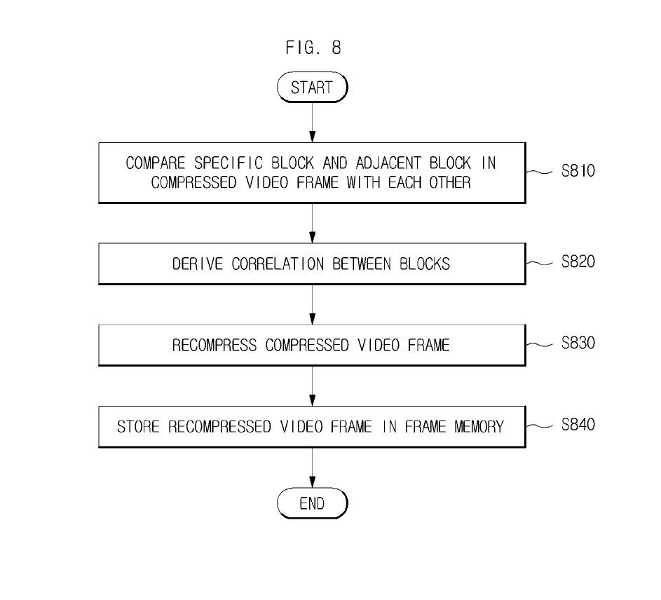

Next, a method of providing recompression of a video of the apparatus 100 of providing recompression of a video will be described. FIG. 8 is a flow chart schematically showing a method of providing recompression of a video according to an exemplary embodiment of the present invention. The following description will be provided with reference to FIGS. 1 to 4 and FIG. 8.

First, the recompressing unit 110 compares the selected block selected from the compressed video frame and the adjacent block adjacent to the selected block with each other (S810). Then, the recompressing unit 110 generates information on a correlation between the blocks obtained by the comparison (S820). Next, the recompressing unit 110 recompresses the compressed video frame based on the information on the correlation between the blocks (S830).

Then, the frame memory controlling unit 120 stores the recompressed video frame in the frame memory 130 (S840).

After S840, the re-reconstructing unit 180 reads the recompressed video frame from the frame memory 130 and re-reconstructs the read recompressed video frame.

The re-reconstructing process of the re-reconstructing unit 180 may be performed in detail as follows. First, the comparison information generating unit 181 generates the information obtained by comparing the selected block and the adjacent block with each other by unpacking the recompressed video frame. Then, the comparison information storing unit 182 stores the information obtained by comparing the selected block and the adjacent block with each other therein. Then, the re-reconstruction controlling unit 183 controls re-reconstruction of the recompressed video frame based on the information obtained by comparing the selected block and the adjacent block with each other.

The present invention may obtain the following effects through the above-mentioned configuration. First, a hardware volume may be decreased while original video data are maintained. Second, a video codec may be processed in real time at a small hardware area without deteriorating video quality. Third, a memory bandwidth may be decreased by 50% without deteriorating video quality, and low power is possible.

Although it has been mentioned that all components configuring the exemplary embodiment of the present invention described hereinabove are combined with each other as one component or are combined and operated with each other as one component, the present invention is not necessarily limited to the above-mentioned exemplary embodiment. That is, all the components may also be selectively combined and operated with each other as one or more component without departing from the scope of the present invention. In addition, although each of all the components may be implemented by one independent hardware, some or all of the respective components which are selectively combined with each other may be implemented by a computer program having a program module performing some or all of functions combined with each other in one or plural hardware. In addition, the computer program as described above may be stored in computer readable media such as a universal serial bus (USB) memory, a compact disk (CD), a flash memory, or the like, and be read and executed by a computer to implement the exemplary embodiment of the present invention. An example of the computer readable media may include magnetic recording media, optical recording media, carrier wave media, and the like.

In addition, unless defined otherwise in the detailed description, all the terms including technical and scientific terms have the same meaning as meanings generally understood by those skilled in the art to which the present invention pertains. Generally used terms such as terms defined in a dictionary should be interpreted as the same meanings as meanings within a context of the related art and should not be interpreted as ideally or excessively formal meanings unless clearly defined in the present specification.

The spirit of the present invention has been described by way of example hereinabove, and the present invention may be variously modified, altered, and substituted by those skilled in the art to which the present invention pertains without departing from essential features of the present invention. Accordingly, the exemplary embodiments disclosed in the present invention and the accompanying drawings do not limit but describe the spirit of the present invention, and the scope of the present invention is not limited by the exemplary embodiments. The scope of the present invention should be interpreted by the following claims and it should be interpreted that all spirits equivalent to the following claims fall within the scope of the present invention.

What is claimed is:

1. An apparatus of providing recompression of a video, comprising:
a recompressing unit recompressing a compressed video frame based on information obtained by comparing a selected block selected from the compressed video frame and an adjacent block adjacent to the selected block with each other; and
a frame memory controlling unit storing the recompressed video frame in a frame memory.

2. The apparatus of providing recompression of a video of claim 1, wherein the recompressing unit includes:
an adjacent block processing unit extracting and storing blocks adjacent to the selected block from the compressed video frame;
a block comparing unit comparing the adjacent block selected among the stored blocks and the selected block with each other in a pixel unit;
a pixel information obtaining unit obtaining information on a first pixel of the selected block having a pixel value that is the same as that of the adjacent block and information on a second pixel of the selected block having a pixel value that is different from that of the adjacent block; and
a recompression controlling unit controlling recompression of the compressed video frame by packing the obtained information on the first pixel and the obtained information on the second pixel.

3. The apparatus of providing recompression of a video of claim 2, wherein the pixel information obtaining unit obtains a pixel value as the information on the first pixel and obtains address information on a pixel and a pixel value as the information on the second pixel.

4. The apparatus of providing recompression of a video of claim 1, further comprising:
a reconstruction memory storing the compressed video frame therein;
a first address generating unit generating address information on a pixel selected from the selected block when the compressed video frame is recompressed;
a re-reconstructing unit reading the recompressed video frame from the frame memory and re-reconstructing the read recompressed video frame; and
a second address generating unit generating address information on a pixel in a block of the recompressed video frame.

5. The apparatus of providing recompression of a video of claim 4, wherein the re-reconstructing unit includes:
a comparison information generating unit generating the information obtained by comparing the selected block and the adjacent block with each other by unpacking the recompressed video frame;
a comparison information storing unit storing the information obtained by comparing the selected block and the adjacent block with each other therein; and
a re-reconstruction controlling unit controlling re-reconstruction of the recompressed video frame based on the information obtained by comparing the selected block and the adjacent block with each other.

6. The apparatus of providing recompression of a video of claim 1, wherein it is mounted in a video codec.

7. A method of providing recompression of a video, comprising:
a recompressing step of recompressing a compressed video frame based on information obtained by comparing a selected block selected from the compressed video frame and an adjacent block adjacent to the selected block with each other; and
a frame memory control step of storing the recompressed video frame in a frame memory.

8. The method of providing recompression of a video of claim 7, wherein the recompressing step includes:
an adjacent block processing step of extracting and storing blocks adjacent to the selected block from the compressed video frame;
a block comparing step of comparing the adjacent block selected among the stored blocks and the selected block with each other in a pixel unit;
a pixel information obtaining step of obtaining information on a first pixel of the selected block having a pixel value that is the same as that of the adjacent block and information on a second pixel of the selected block having a pixel value that is different from that of the adjacent block; and
a recompression controlling step of controlling recompression of the compressed video frame by packing the obtained information on the first pixel and the obtained information on the second pixel.

9. The method of providing recompression of a video of claim 8, wherein in the pixel information obtaining step, a pixel value is obtained as the information on the first pixel and address information on a pixel and a pixel value are obtained as the information on the second pixel.

10. The method of providing recompression of a video of claim 7, further comprising a re-reconstructing step of reading the recompressed video frame from the frame memory and re-reconstructing the read recompressed video frame.

11. The method of providing recompression of a video of claim 10, wherein the re-reconstructing step includes:
a comparison information generating step of generating the information obtained by comparing the selected block and the adjacent block with each other by unpacking the recompressed video frame;
a comparison information storing step of storing the information obtained by comparing the selected block and the adjacent block with each other therein; and
a re-reconstruction controlling step of controlling re-reconstruction of the recompressed video frame based on the information obtained by comparing the selected block and the adjacent block with each other.

12. The method of providing recompression of a video of claim 7, wherein it is used when a video codec is generated.
